(19) United States
(12) Patent Application Publication
(10) Pub. No.: US 2020/0012489 A1
(43) Pub. Date: Jan. 9, 2020

(54) COMBINED FILE FIRMWARE UPGRADE

(71) Applicant: Seagate Technology LLC, Cupertino, CA (US)

(72) Inventors: Choo Swee Kieong, Singapore (SG); Chng Yong Peng, Singapore (SG); Wang Lina, Singapore (SG)

(21) Appl. No.: 16/028,746

(22) Filed: Jul. 6, 2018

(51) Int. Cl. G06F 8/654

(52) U.S. Cl. CPC G06F 8/654

(57) ABSTRACT

A method of combined file firmware upgrade includes providing a combo file comprising a plurality of firmware files for a plurality of data storage device product categories. The method also includes downloading the combo file to a data storage device that belongs to one of the plurality of data storage device product categories. The method further includes comparing parameters of the data storage device with parameters of individual firmware files of the plurality of firmware files. When parameters of a particular one of the plurality of firmware files are found to correspond with the parameters of the data storage device, the method includes utilizing the particular one of the plurality of firmware files to perform an automatic firmware upgrade in the data storage device.

### SUMMARY

A method of performing an automatic firmware upgrade on a device is provided. The method includes providing a combo file comprising a plurality of firmware files for a plurality of data storage device product categories. The method also includes downloading the combo file to a data storage device that belongs to one of the plurality of data storage device product categories. The method further includes comparing parameters of the data storage device with parameters of individual firmware files of the plurality of firmware files. When parameters of a particular one of the plurality of firmware files are found to correspond with the parameters of the data storage device, the method includes utilizing the particular one of the plurality of firmware files to perform an automatic firmware upgrade in the data storage device.

In another embodiment, a method is provided. The method includes generating a plurality of firmware files for upgrading a plurality of devices wherein each firmware file of the plurality of firmware files includes a header and a firmware code portion. The method also includes combining the plurality of firmware files into a combo file. The method further includes providing a combo file header for the combo file, wherein the combo file header includes parameters of the combo file to enable one of the plurality of devices to select one of the plurality of firmware files for compatibility.

In yet another embodiment, a computer-readable storage medium having encoded therein computer-executable instructions for programming a computing device is provided. The computer-executable instructions include a combo file comprising a plurality of firmware files for updating a plurality of devices. The computer-executable instructions also include a firmware file header for each of the plurality of firmware files. The computer-executable instructions further include a combo file header for the combo file, wherein the combo file header includes parameters of the combo file to enable one of the plurality of devices to select one of the plurality of firmware files for compatibility to perform an automatic firmware upgrade in the data storage device.

This summary is not intended to describe each disclosed embodiment or every implementation of the combined file firmware upgrade technique. Many other novel advantages, features, and relationships will become apparent as this description proceeds. Other features and benefits that characterize embodiments of the disclosure will be apparent upon reading the following detailed description and review of the associated drawings.

### BRIEF DESCRIPTION OF THE DRAWINGS

FIG. 1 illustrates a block diagram of an example apparatus having a data storage device in accordance with embodiments of the present disclosure.

FIGS. 2A and 2B illustrate block diagrams of a combo file according to embodiments of the present disclosure.

FIGS. 3A and 3B illustrate download modes for a combo file according to an embodiment of the present disclosure.

FIGS. 4A and 4B illustrate block diagrams of a download process according to embodiments of the present disclosure.

FIG. 5 illustrates a block diagram of an example combo file in accordance with embodiments of the present disclosure.

FIG. 6 is a flow diagram of a method for automatically upgrading firmware on a data storage device in accordance with one embodiment of the present disclosure.

### DETAILED DESCRIPTION

Although the present disclosure has been described with reference to embodiments, workers skilled in the art will recognize that changes may be made in form and detail without departing from the scope of the disclosure. The present disclosure generally describes a method for automatically matching firmware to a product during a field upgrade.

In order to enable utilization for different customer applications, a wide variety of data storage device products may be offered under a product family tree. The variety of data storage device products that enable the utilization for different applications may use different firmware. Further, each product may include different variants, such as single disk or dual disk variant when the data storage device is a hard disk drive. Firmware code released for field upgrade may include a plurality of firmware files. Each of the plurality of firmware files may be compatible with a particular data storage device product or product category, but not compatible with all data storage device product categories. Thus, firmware upgrades, which may be carried out by field engineers, involve matching various firmware codes to specific data storage device configurations to avoid data storage device malfunction through firmware mismatch. Manually matching firmware to a specific data storage device configuration is time consuming and may result in errors. To address these problems, embodiments of the disclosure provide a combined file firmware upgrade technique.

It should be noted that the same reference numerals are used in different figures for same or similar elements. It should also be understood that the terminology used herein is for the purpose of describing embodiments, and the terminology is not intended to be limiting. Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that, unless indicated otherwise, any labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” “intermediate” and the like are used for convenience and are not intended to imply, for example, any particular fixed location, orientation, or direction. Instead, such labels are used to reflect, for example, relative location, orientation, or directions. It should also be understood that the singular forms of “a,” “an,” and “the” include plural references unless the context clearly dictates otherwise.

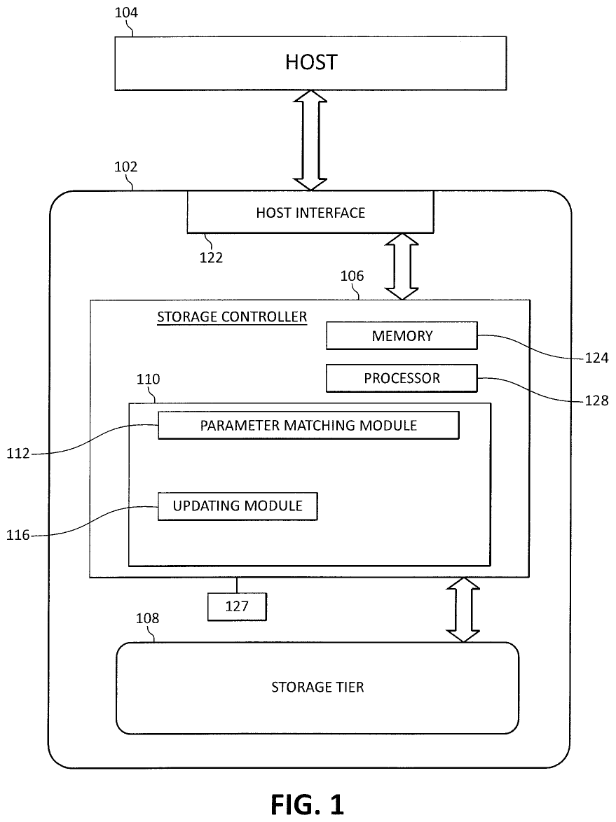

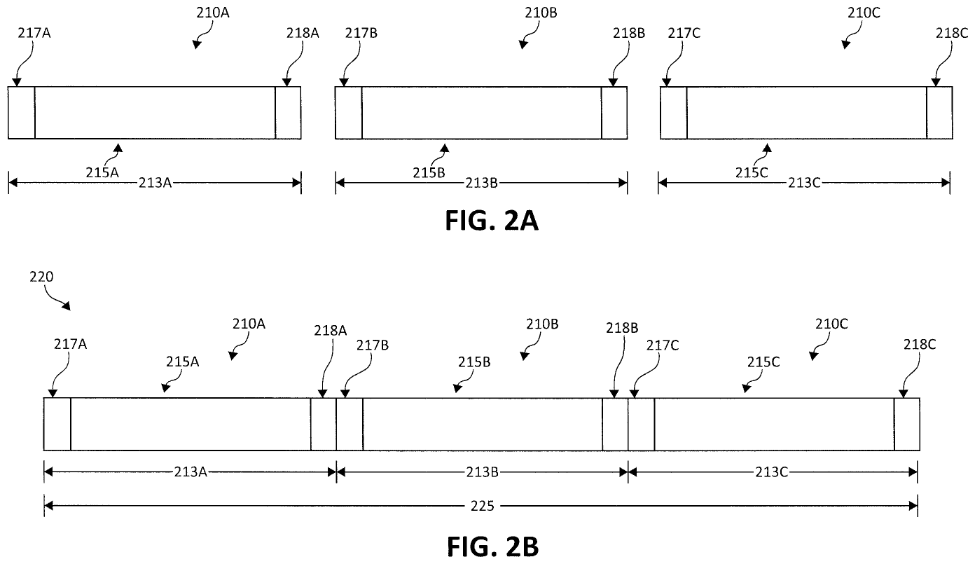

FIG. 1 is a block diagram of an example apparatus that includes a data storage device 102 in accordance with an embodiment of the present disclosure. Data storage device 102 includes a storage controller or control circuit 106 that communicatively couples a storage tier 108 to a host 104 via a host interface 122. In an implementation, the storage tier 108 is a dynamic storage tier. The storage controller 106 provides a mechanism to allow the host 104 to store data to and retrieve data from the storage tier 108, such as firmware file 210 seen in FIG. 2A. In an implementation, the storage tier 108 may be a main data store. The storage tier 108 may include without limitation one or more of magnetic data storage discs, optical data storage discs, non-volatile random access memory (RAM), such as NAND flash memory and a volatile RAM storage medium such as dynamic random access memory (DRAM).

The storage controller 106 may utilize communication interfaces and protocols including SATA (serial advanced technology attachment), SCSI (small computer system interface), eSATA (external serial advanced technology attachment), SAS (serial attached SCSI), USB (universal serial bus), and others to communicate with the host 104 via the host interface 122.

As can be seen in FIG. 1, the storage controller 106 also includes a memory 124 that may be used for storing data and/or one or more modules such as 110 in some embodiments. It should be noted that, in different embodiments, module 110 may comprise hardware, software and/or firmware. In one embodiment, the memory 124 may serve as a system memory into which code for a firmware upgrade may be downloaded. In other embodiments, a separate memory 127 may serve as the system memory into which the code for the firmware upgrade may be downloaded. The storage controller 106 further includes a processor 128. The processor 128 may perform functions of the storage controller 106 including functions disclosed herein as performed by module 110. The processor 128 may execute instructions stored on non-transitory computer readable media to perform the functions of the storage controller 106.

In one embodiment, module 110 may include multiple sub-modules. The sub-modules may include a parameter matching module 112 and an updating module 116. The host 104 may contain a plurality of different firmware files including a firmware file for a data storage device 102 upgrade. In an implementation, the plurality of firmware files from host 104 may be sent to sub-modules of module 110 to update the firmware of data storage device 102. The parameter matching module 112 may be used to validate at least one of the firmware from from host 104 by matching parameters of data storage device 102 to a corresponding firmware file of the plurality of files from host 104. Updating module 116 may then perform the update of the data storage device 102 with the validated firmware file from host 104.

FIGS. 2A and 2B illustrate block diagrams of a plurality of firmware files which may be combined into a combo file according to embodiments of the present disclosure. FIG. 2A illustrates firmware files 210A, 210B, and 210C each of which may correspond to a different product and upgrade one of a plurality of devices. Each firmware file 210 includes firmware code 215 with a header 217 and a footer 218 which have a firmware file length 213. Each header 217 or footer 218 may contain information regarding the code 215 of their respective firmware file 210. A device 102 may have various parameters such as drive type, block point number, or servo revision, and header 217 may include information on the parameters of its respective firmware file 210 to be matched for compatibility to device 102, such that a compatible firmware file 210 may be selected based on the matched parameters (e.g., by parameter matching module 112 of FIG. 1). Thus, one of the plurality of firmware files 210 may be selected for compatibility by one of the plurality of devices 102 when the combo file is downloaded.

FIG. 2B illustrates the plurality of firmware files 210 combined into a single file, e.g., a combo file 220. The firmware files 210A, 210B, and 210C may be combined into combo file 220 with total file length or combo file length 225. Combo file length 225 equals the firmware file length 213 of each of the plurality of firmware files 210 added together, e.g., 213A+213B+213C. Combining the plurality of firmware files 210 into combo file 220 allows firmware configurations for a plurality of devices to be accessible, and enables the selection of firmware file 210 by matching with corresponding parameters of device 102 to be carried out internally by a host or device firmware (e.g., such as by parameter matching module 112). This reduces the risk of error when matching and applying firmware to a product for upgrade.

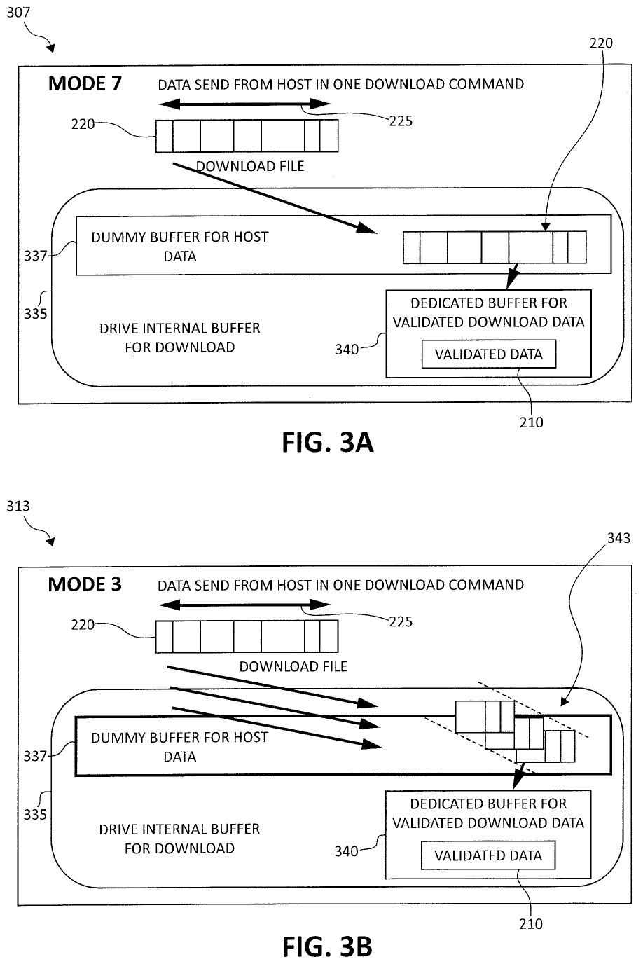

Typically, when device 102 is to be upgraded, a file is selected (such as by a field engineer) and then downloaded to an internal buffer of the device 102 (e.g., a buffer allocated in memory 124 or memory 127 of FIG. 1). The file in the internal buffer is then validated (e.g., by module 112 of FIG. 1) and the drive firmware may be upgraded (e.g., by updating module 116 of FIG. 1). Two downloading modes are used depending on the host 104 download configurations. In a first download mode (see mode 307 of FIG. 3A), a firmware file may be downloaded as one file in a single command, and in a second download mode (see mode 313 of FIG. 3B), the firmware file may be segmented and sent to the drive buffer in a plurality of commands. The second download mode further includes retrieving the firmware file length 213 from the firmware file header 217 of each of the plurality of firmware files 210 to determine the combo file length 225.

FIGS. 3A and 3B illustrate downloading modes for a combo file according to the present disclosure. FIG. 3A illustrates a block diagram of first download mode 307 in which a data file, e.g., combo file 220, with file length 225 is downloaded from a host (e.g., host 104) to a device (e.g., device 102). Multiple buffers may be allocated to enable an automatic firmware upgrade. The data or combo file 220 stored in the host 104 is first downloaded into a first buffer or dummy memory buffer 337 for host data on a device's internal memory buffer 335. The combo file 220 is validated in the dummy buffer 337 by matching device parameters to the parameters of the corresponding firmware file 210. The selected, or validated, firmware file 210 may then be transferred to a second buffer, or dedicated buffer 340 in internal buffer 335 for upgrading the device 102. Although multiple buffers are described, one skilled in the art will recognize that buffers may be partitions within a memory or partitions separated among a plurality of memories without departing from the scope of the disclosure.

FIG. 3B illustrates a block diagram of second download mode 313 in which a data file, e.g., combo file 220, with file length 225 is segmented and downloaded from host 104 to device 102 in a plurality of download commands. The data or combo file 220 is broken into a plurality of segments 343 and each of the plurality of segments 343 is first downloaded into a dummy buffer 337 for host data on a device's internal buffer 335. The combo file 220 may then be validated in dummy buffer 337 by matching device parameters to the corresponding firmware. The selected firmware file 210 may then be transferred to a dedicated buffer 340 in internal buffer 335 for upgrading the device 102.

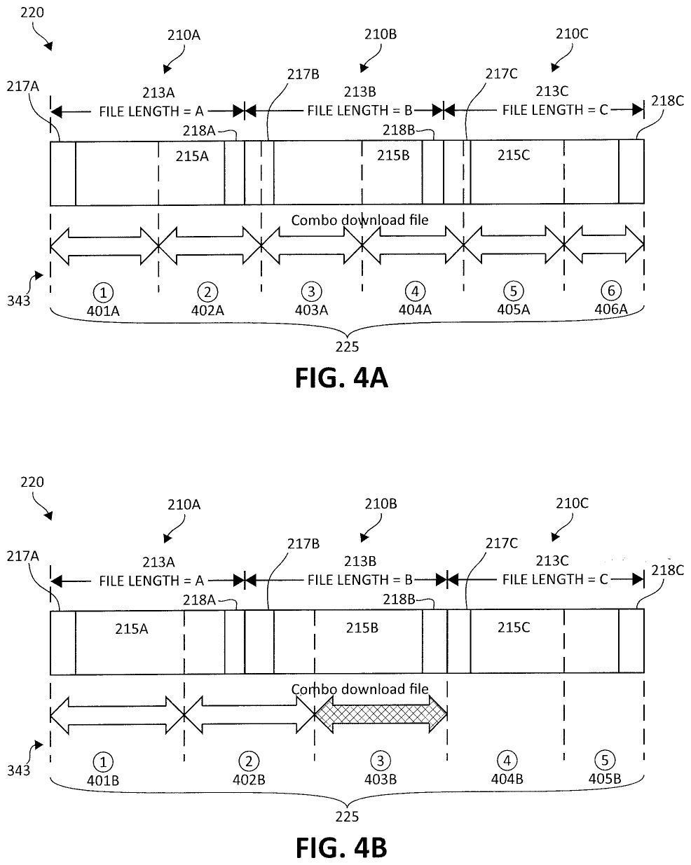

FIG. 4A illustrates a block diagram of an exemplary data file segmentation for second download mode 313. The data file or combo file 220 using second download mode 313 may be broken into a plurality of segments 343 and sent to device 102 by a plurality of download commands. The header 217 of each firmware file 210 may include a variety of parameters and information including firmware file lengths 213. The download firmware (e.g., firmware of storage controller 106) may calculate the total file size or combo file length 225 based on the sum of the individual firmware length 213. For example, the header 217A of firmware file 210A includes file length 213A of firmware file 210A. As the combo file 220 is broken into the plurality of segments 343 and transferred to the device 102, each header 217 is accessed and the firmware file length 213 is read. The last download command is determined by the download firmware when the total download length, e.g., the combo file length 225, is equal to the sum of the individual firmware file lengths 213.

Combo file 220 includes three firmware files 210A, 210B, and 210C each with a file length 213A, 213B, and 213C respectively, where combo file length 225 is equal to the sum of file lengths (e.g., 213A+213B+213C). In FIG. 4A, combo file 220 is broken into a plurality of segments 343 and sent from the host 104 using a plurality of download commands. Here, six download commands are used break combo file 220 into six segments 401A to 406A. During a download from the host 104, the download firmware will detect that total host data received is X, which is the total number of segments 343 received, and total expected file size is Y, the sum of the individual firmware file length 213. The download firmware correctly calculates the combo file length 225 when the download firmware detects that total host data X equals total firmware file length Y and deduces that it is the last segment 343 of combo file 220, e.g., that segment 406A is the last segment. Thus, when the download firmware detects the last command and correctly calculates the combo file size it will end the download command correctly.

FIG. 4B illustrates a block diagram of data file segmentation of second download mode 313 when a combo file size 225 is wrongly determined. When an incorrect combo file size is deduced, the download command may be incorrectly terminated and subsequent download commands aborted. One example of when combo file size may be incorrectly deduced occurs when the end of a segment also equals the end of one of a plurality of firmware files. In FIG. 4B, combo file 220 is separated into a plurality of segments 343, however, here the combo file 220 is broken into five segments (e.g., segments 401B to 405B), where one segment (e.g., segment 403B) ends at a firmware file boundary between firmware file 210B and 210C (e.g., after footer 218B).

Not every header 217 may be read if a segment ends at the end of a firmware file 210. As can be seen during this download, the total host data X is equal to three segments (e.g., 401B+402B+403B) and the total expected file size Y is equal to the sum of firmware file lengths for firmware files 210A and 210B (e.g., firmware file lengths 213A and 213B). Here, both segment 403B and footer 218B end at the same point. Thus, the download firmware (e.g., firmware of storage controller 106) detects that X is equal to Y and deduces incorrectly that segment 403B is the last segment of the host data (e.g., combo file 220). The total expected file size Y is incorrect because firmware file header 217C has not been read and the firmware file length 213C is unknown. The download command will be terminated and subsequent download commands, e.g., segment 404B and segment 405B, will be aborted due to the combo file size 225 being determined incorrectly. Thus, firmware file 210C will not be downloaded and the automatic firmware upgrade may fail.

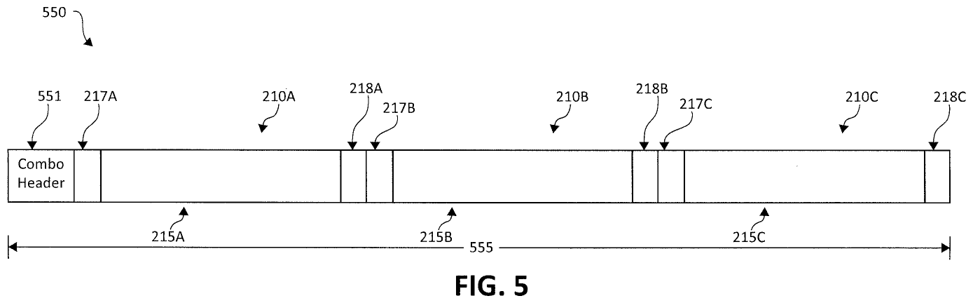

FIG. 5 illustrates an embodiment according to the present disclosure wherein a combo file header is included with a combo file, e.g., combo file 220. A combo file 550 with a combo file header 551 includes various parameters and information regarding the combo file 550 including the combo file length 555. Combo file 550 is similar to combo file 220, such that it includes a plurality of firmware files 210 with firmware code 215 with header 217, footer 218, and firmware file length 213. Download firmware (e.g., firmware of storage controller 106) may obtain combo file length 555 from combo file header 551 to resolve possible incorrect download command termination issues as discussed in second download mode 313. Incorrect termination issues may be resolved as the download firmware does not need to deduce an expected file size Y as seen in FIG. 4B, but rather has a known file length prior to processing firmware file headers 217. Thus, combo file header 551 enables download firmware to avoid incorrectly terminating a download. Combo file 550 therefore enables the download firmware to intelligently select a firmware file that is compatible with a corresponding device configuration.

For example, when upgrading device 102, the combo file 550 is downloaded to dummy buffer 337 in the internal buffer 335, and the total combo file length 555 is obtained from the combo file header 551. Next, the firmware may process each header 217 to determine the individual firmware file length 213 and device parameters that each of the plurality of firmware files 210 correspond to. The parameters of the device 102 are matched against the plurality of firmware file 210 device parameters, and one firmware file 210 is validated, or selected, based on the matched parameters. Finally, the validated firmware file 210 is transferred to the dedicated buffer 340 for updating.

Combo file 550 may be used in either download mode 307 or download mode 313. In download mode 307, the combo file 550 may include a plurality of firmware files 210 which may then be sent to device 102 in a single download command. Although the number firmware files that may be sent to device 102 depends in part on the size of the buffer allocated for download (e.g., memory 127 or dummy buffer 337), the number of firmware files 210 that may be combined into combo file 550 need not be so limited, and a plurality of firmware files 210 for a plurality of devices 102 or products may be combined into a combo file 550 for a field upgrade. In another embodiment, the combo file length 555, e.g., the number of firmware files 210 combined into combo file 550, need not be so limited as with download mode 313. As only a portion of buffer 335 is used when a plurality of segments 343 are sent in multiple download commands, there is no combo file length limitation, and combo file 550 may contain any number of firmware files 210 when using download mode 313.

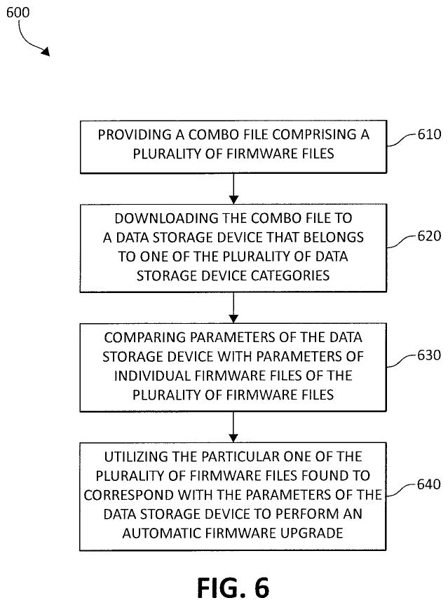

FIG. 6 is a flow diagram of a method 600 for automatically upgrading firmware on a data storage device (such as data storage device 102). The method starts at block 610 which includes providing a combo file comprising a plurality of firmware files. The plurality of firmware files may be for a variety of data storage device product categories. Next, block 620 includes downloading the combo file to a data storage device that belongs to one of the plurality of data storage device categories. Block 630 provides comparing parameters of the data storage device with parameters of individual firmware files of the plurality of firmware files. Lastly, block 640 provides utilizing the particular one of the plurality of firmware files found to correspond with the parameters of the data storage device to perform an automatic firmware upgrade.

The methods and software described herein include many advantages. First, the methods provide a seamless field firmware upgrade for both customers and field engineers. For example, a combo file as described herein may be provided to a customer who has multiple types of devices and configurations, such that upgrade code for all product configurations are provided in a single file for automatic device upgrade. Although embodiments as described herein discusse firmware for upgrading data storage devices, the embodiments need not be so limited, and a variety of computer-executable instructions may be applied to a variety of products according to the embodiments disclosed herein. The methods can be applied across different firmware configurations and may be expanded across different products. The methods may also be applied across different system-on-chip devices.

Another advantage includes that a combo file, such as combo file 550, will maintain integrity during download such that the firmware's integrity will not be affected during download. A download using the embodiments discussed is also transparent to security designs and the signing process of individual firmware will not be affected. Further, download time may not be significantly affected by the methods discussed herein, as data transfer may be accomplished through a native interface. The embodiments as described may also save extensive firmware code space by splitting up different firmware features under different firmware configurations. Further, the embodiments may also be applied to reduce firmware footprint and thereby further reduce firmware memory costs.

In accordance with various embodiments, the methods described herein may be implemented as one or more software programs running on one or more computer processors or controllers such as those included in device 102. Dedicated hardware implementations, including but not limited to, application specific integrated circuits, programmable logic arrays, and other hardware devices can likewise be constructed to implement the methods described herein.

The illustrations of the embodiments described herein are intended to provide a general understanding of the method of the various embodiments. The illustrations are not intended to serve as a complete description of all of the elements and features of methods and systems described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

In addition, in the foregoing Detailed Description, various features may be grouped together or described in a single embodiment for the purpose of streamlining the disclosure. This disclosure is not to be interpreted as reflecting an intention that the claimed embodiments employ more features than are expressly recited in each claim. Rather, as the following claims reflect, inventive subject matter may be directed to less than all of the features of any of the disclosed embodiments.

The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

1. A method comprising:
providing a combo file comprising a plurality of firmware files for a plurality of different data storage device products;
downloading the combo file to a data storage device that belongs to one of a plurality of different data storage device products;
comparing parameters of the data storage device with parameters of individual firmware files of the plurality of firmware files; and
when parameters of a particular one of the plurality of firmware files are found to correspond with the parameters of the data storage device, utilizing the particular one of the plurality of firmware files to perform an automatic firmware upgrade in the data storage device.

2. The method of claim 1, and wherein downloading the combo file further comprises downloading the combo file to an internal memory buffer of the data storage device.

3. The method of claim 2, and further comprising first downloading the combo file to a dummy buffer of the internal memory buffer of the data storage device.

4. The method of claim 3, and wherein the comparing the parameters of the data storage device with the parameters of individual firmware files of the plurality of firmware files occurs in the dummy buffer of the internal memory buffer.

5. The method of claim 4, and wherein the particular one of the plurality firmware files found to correspond with the parameters of the data storage device is a validated firmware file.

6. The method of claim 5, and further comprising transferring the validated firmware file to a dedicated buffer of the internal memory buffer to perform the automatic firmware upgrade in the data storage device.

7. The method of claim 1, and further comprising downloading the combo file to the data storage device with a single download command.

8. The method of claim 1, and further comprising downloading the combo file to the data storage device with a plurality of download commands.

9. The method of claim 8, wherein the combo file is broken into a plurality of segments.

10. The method of claim 1, wherein each of the plurality of firmware files includes a header.

11. The method of claim 10, and wherein the header for each of the plurality of firmware files includes parameters of each individual firmware file.

12. The method of claim 1, and further comprising a combo file header for the combo file.

13. The method of claim 12, and wherein the combo file header includes parameters of the combo file.

14. The method of claim 13, and wherein parameters of the combo file include a combo file length.

15. A method comprising:
generating a plurality of firmware files for upgrading a plurality of different data storage device products, wherein each firmware file of the plurality of firmware files includes a header and a firmware code portion;
combining the plurality of firmware files into a combo file; and
providing a combo file header for the combo file, wherein the combo file header includes parameters of the combo file to enable a data storage device of one of the plurality of different data storage device products to select one of the plurality of firmware files for compatibility.

16. The method of claim 15, and wherein the header for each of the plurality of firmware files includes parameters of each individual firmware file.

17. The method of claim 16, and further comprising selecting one of the plurality of firmware files for compatibility with one of the plurality of devices to perform an automatic firmware upgrade in the one of the plurality of devices.

18. A non-transitory computer-readable storage medium having encoded therein computer-executable instructions for programming a computing device comprising:
a combo file comprising a plurality of firmware files for updating a plurality of different data storage device products;
a firmware file header for each of the plurality of firmware files; and
a combo file header for the combo file, wherein the combo file header includes parameters of the combo file to enable a data storage device of one of the plurality of different data storage device products to select one of the plurality of firmware files for compatibility to perform an automatic firmware upgrade in the device.

19. The non-transitory computer-readable storage medium of claim 18, and wherein the firmware file header for each of the plurality of firmware files includes parameters of each individual firmware file.

20. The non-transitory computer-readable storage medium of claim 18, and wherein the parameters of the combo file include combo file length.
